(19) United States
(12) Patent Application Publication
(10) Pub. No.: US 2017/0253714 A1
(43) Pub. Date: Sep. 7, 2017

(54) Sustainable Process for the Recycling of Polyethylene Phthalate

(71) Applicant: Sabic Global Technologies, B.V., Bergen Op Zoom (NL)

(72) Inventors: Zheng LIU, Sugar Land, TX (US); Navinchandra ASTHANA, Sugar Land, TX (US)

(21) Appl. No.: 15/363,235

(22) Filed: Nov. 29, 2016

Related U.S. Application Data
(63) Continuation of application No. PCT/US2016/020857, filed on Mar. 4, 2016.

(51) Int. Cl. C08J 11/24

(52) U.S. Cl. CPC C08J 11/24; C08J 2367/00

(57) ABSTRACT

A method of processing one or more streams in a phthalate-containing polymer recycling system, the method comprising receiving an extract stream and a raffinat4e stream from a liquid chromatography unit, which is part of the polymer recycling system, wherein the extract stream comprises a bis(hydroxyalkyl) phthalate monomer, C₂₋₅ alkylene diol, and solvent, and wherein the raffinate stream comprises first impurities, C₂₋₅ alkylene diol, and solvent; vacuum distilling the extract stream to produce a first solvent stream and a monomer and diol stream comprising the bis(hydroxyalkyl) phthalate monomer and C₂₋₅ alkylene diol; subjecting the monomer and diol stream to steam separation to produce a monomer stream comprising the bis(hydroxyalkyl) phthalate monomer and water, and a diol stream comprising C₂₋₅ alkylene diol and water; and vacuum distilling the raffinate stream to produce a second solvent stream and a first impurities stream comprising first impurities and C₂₋₅ alkylene diol.

### CROSS-REFERENCE TO RELATED APPLICATIONS

The present application is a a continuation of and claims priority to International Application No. PCT/US2016/020857 filed Mar. 4, 2016, and entitled “Sustainable Process for the Recycling of Polyethylene Phthalate,” which application is incorporated by reference herein in its entirety.

### TECHNICAL FIELD

The present disclosure relates to methods of recycling polyester polymers, more specifically methods of recycling phthalate-containing polymers, such as poly(ethylene terephthalate).

### BACKGROUND

Polyesters such as poly(ethylene terephthalate) (PET) have excellent thermal and mechanical properties. The main applications of PET include the manufacture of video and audio tapes, textiles, X-ray films, and food packaging, particularly for water and soft-drink bottles. In 2009, the world consumption of PET packaging alone was about 15.5 metric tons, and it has been estimated to increase to almost 19 metric tons by 2017, a 5.2% growth rate per year. Despite its many benefits, items made from PET have typically been used for a short period of time and then disposed of, especially water and soft-drink bottles.

Accumulation of waste resulting from petroleum-based plastics such as PET has become an environmental concern worldwide. PET has been present in nature for only a relatively short period of time, and is not biodegradable (e.g., microorganisms have not yet developed new enzyme structures to consume them). As a result, articles made from PET often end their life cycles either buried in landfill sites or burned, which can generate unwanted gaseous emissions. Therefore, other end of life solutions for PET, such as recycling, have been proposed.

One approach to PET recycling is based on the depolymerization of PET. Many processes for PET depolymerization have been studied, depending on the end use of the reclaimed products. Generally, conventional PET depolymerization processes present difficulty in separating the reclaimed products in a sufficiently pure state for further use.

In some instances, after separating the monomer (e.g., bis(2-hydroxyethyl) terephthalate or BHET) from the composition comprising the depolymerized terephthalate-containing polymer, the BHET can still be dissolved in solvent(s) along with alcohols such as ethylene glycol used in the depolymerization of PET. It should be noted that regular flash and/or distillation does not work for sufficiently isolating the BHET from a liquid phase containing solvent(s) and ethylene glycol.

Further, some methods can utilize rather large amounts of solvent(s) due to the low solubility of PET in such solvent(s), wherein alcohols such as ethylene glycol used in the depolymerization of PET can be mixed with the solvent(s). Thus, there is an ongoing need for the development of sustainable processes for the recycling of PET based on depolymerization, including purifying depolymerization products and recycling solvent(s).

### BRIEF SUMMARY

Disclosed herein is a method of processing one or more streams in a phthalate-containing polymer recycling system, the method comprising (a) receiving an extract stream from a liquid chromatography unit, wherein the liquid chromatography unit is part of the phthalate-containing polymer recycling system, and wherein the extract stream comprises a bis(hydroxyalkyl) phthalate monomer, a C₂₋₅ alkylene diol, and a solvent, (b) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol, and (c) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water.

Also disclosed herein is a method of processing one or more streams in a phthalate-containing polymer recycling system, the method comprising (a) receiving a raffinate stream from a liquid chromatography unit, wherein the liquid chromatography unit is part of the phthalate-containing polymer recycling system, and wherein the raffinate stream comprises first impurities, a C₂₋₅ alkylene diol, and a solvent, (b) vacuum distilling at least a portion of the raffinate stream to produce a second solvent stream and a first impurities stream, wherein the first impurities stream comprises first impurities and the C₂₋₅ alkylene diol, and (c) recycling at least a portion of the second solvent stream to the liquid chromatography unit.

Further disclosed herein is a method of processing one or more streams in a phthalate-containing polymer recycling system, the method comprising (a) depolymerizing a phthalate-containing polymer to provide bis(hydroxyalkyl) phthalate, (b) separating the bis(hydroxyalkyl) phthalate from a composition comprising depolymerized phthalate-containing polymer in a continuous multi-column liquid chromatography unit to produce an extract stream and a raffinate stream, wherein the continuous multi-column liquid chromatography unit is part of the phthalate-containing polymer recycling system, wherein the extract stream comprises a bis(hydroxyalkyl) phthalate monomer, a C₂₋₅ alkylene diol, and a solvent, and wherein the raffinate stream comprises first impurities, a C₂₋₅ alkylene diol, and a solvent, (c) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol, (d) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water, and (e) vacuum distilling at least a portion of the raffinate stream to produce a second solvent stream and a first impurities stream, wherein the first impurities stream comprises first impurities and the C₂₋₅ alkylene diol.

### BRIEF DESCRIPTION OF THE DRAWINGS

For a detailed description of the preferred embodiments of the disclosed methods, reference will now be made to the accompanying drawing in which:

FIGS. 1A and 1B display a schematic of a sustainable process for recycling phthalate-containing polymers.

### DETAILED DESCRIPTION

Disclosed herein are methods for recycling phthalate-containing polymers. Also disclosed herein are methods of processing one or more streams in a phthalate-containing polymer recycling system. In an embodiment, the method can comprise (a) depolymerizing a phthalate-containing polymer to provide bis(hydroxyalkyl) phthalate; (b) separating the bis(hydroxyalkyl) phthalate from a composition comprising depolymerized phthalate-containing polymer in a liquid chromatography unit to produce an extract stream and a raffinate stream, wherein the liquid chromatography unit is part of the phthalate-containing polymer recycling system, wherein the extract stream comprises a bis(hydroxyalkyl) phthalate monomer, a C₂₋₅ alkylene diol, and a solvent, and wherein the raffinate stream comprises first impurities, a C₂₋₅ alkylene diol, and a solvent; (c) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol; (d) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water; and (e) vacuum distilling at least a portion of the raffinate stream to produce a second solvent stream and a first impurities stream, wherein the first impurities stream comprises first impurities and the C₂₋₅ alkylene diol. In such embodiment, the method can further comprise recycling at least a portion of the first solvent stream and/or at least a portion of the second solvent stream to the liquid chromatography unit. In some embodiments, the liquid chromatography unit can be a continuous multi-column liquid chromatography unit. In an embodiment, the steam separation can comprise steam precipitation.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed herein. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The endpoints of all ranges directed to the same component or property are inclusive of the endpoint and independently combinable. The term “from more than 0 to an amount” means that the named component is present in some amount more than 0, and up to and including the higher named amount.

The terms “a,” “an,” and “the” do not denote a limitation of quantity, but rather denote the presence of at least one of the referenced item. As used herein the singular forms “a,” “an,” and “the” include plural referents.

As used herein, “combinations thereof” is inclusive of one or more of the recited elements, optionally together with a like element not recited, e.g., inclusive of a combination of one or more of the named components, optionally with one or more other components not specifically named that have essentially the same function. As used herein, the term “combination” is inclusive of blends, mixtures, alloys, reaction products, and the like.

Reference throughout the specification to “an embodiment,” “another embodiment,” “other embodiments,” “some embodiments,” and so forth, means that a particular element (e.g., feature, structure, property, and/or characteristic) described in connection with the embodiment is included in at least an embodiment described herein, and may or may not be present in other embodiments. In addition, it is to be understood that the described element(s) can be combined in any suitable manner in the various embodiments.

As used herein, the terms “inhibiting” or “reducing” or “preventing” or “avoiding” or any variation of these terms, include any measurable decrease or complete inhibition to achieve a desired result.

As used herein, the term “effective,” means adequate to accomplish a desired, expected, or intended result.

As used herein, the terms “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”) are inclusive or open-ended and do not exclude additional, unrecited elements or method steps.

Unless defined otherwise, technical and scientific terms used herein have the same meaning as is commonly understood by one of skill in the art.

Compounds are described herein using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through the carbon of the carbonyl group.

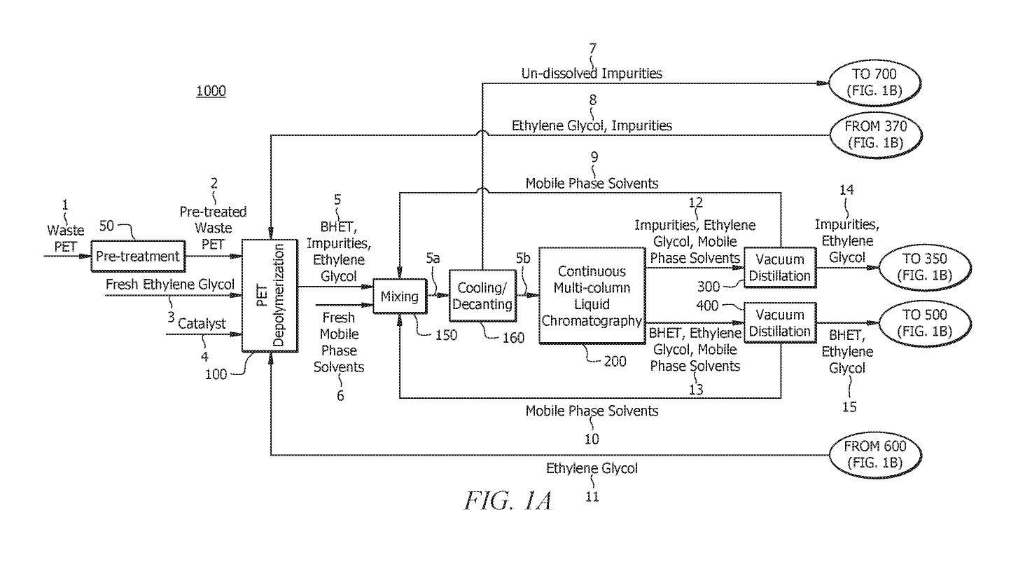

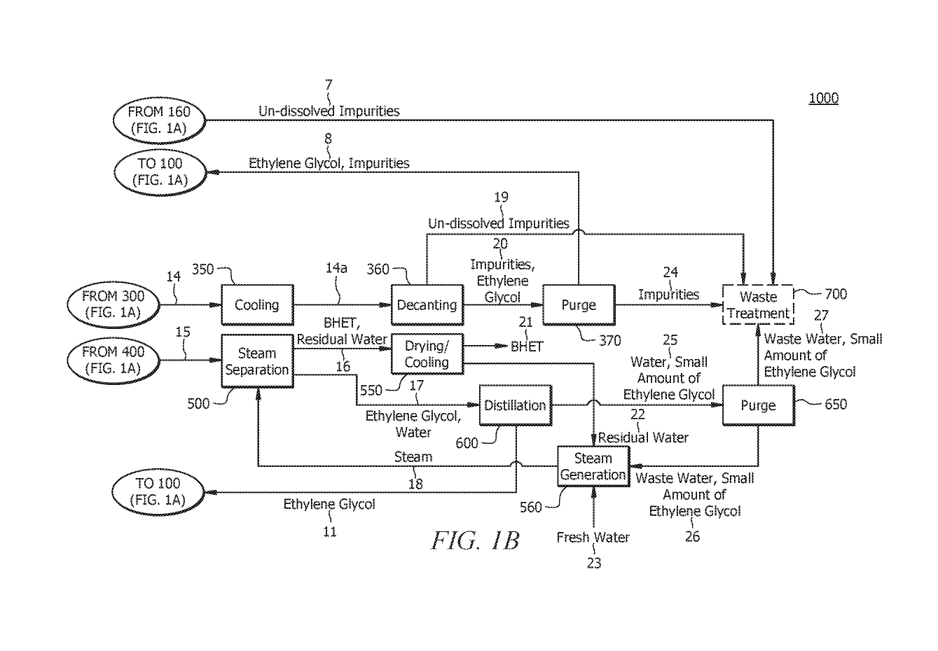

Referring to the embodiment of FIG. 1, a phthalate-containing polymer recycling system 1000 is disclosed. The phthalate-containing polymer recycling system 1000 generally comprises a pre-treatment unit 50; a depolymerization unit 100; a mixing unit 150; a cooling/decanting unit 160; a liquid chromatography unit 200 (e.g., a continuous multi-column liquid chromatography unit); a vacuum distillation unit 300 (e.g., a second vacuum distillation unit); a cooling unit 350; a decanting unit 360; a purge unit 370; a vacuum distillation unit 400 (e.g., a first vacuum distillation unit); a steam separation unit 500; a drying/cooling unit 550; a steam generation unit 560; a distillation unit 600; a purge unit 650; and a waste treatment unit 700. As will be appreciated by one of skill in the art, and with the help of this disclosure, phthalate-containing polymer recycling system components can be in fluid communication with each other through any suitable conduits (e.g., pipes, streams, etc.).

In an embodiment, the methods for recycling phthalate-containing polymers as disclosed herein can integrate (e.g., combine) depolymerization of phthalate-containing polymers with separation via liquid chromatography of depolymerized polymers (e.g., depolymerized phthalate-containing polymers) from impurities (e.g., oligomers, dimers, trimers, pigments, labels, dirt, etc.), and with further recovery and optional recycling of monomers and solvents. While the present disclosure will be discussed in detail in the context of recycling phthalate-containing polymers, it should be understood that the methods disclosed herein can be used in conjunction with any polymers compatible with the methods and materials disclosed herein.

In an embodiment, the phthalate-containing polymers can comprise a terephthalate-containing polymer. The phthalate-containing polymer (e.g., terephthalate-containing polymer) can comprise phthalate ester units (e.g., terephthalate ester units), optionally in combination with other types of polymer units. The phthalate-containing polymer can be a phthalate-containing polyester (e.g., terephthalate-containing polyester), and most preferably a polyester comprising ethylene phthalate repeat units (e.g., ethylene terephthalate repeat units). For purposes of the disclosure herein, the phthalate-containing polymer is not limited to a linear homopolymer. For example, a phthalate-containing polymer can include branched, hyperbranched, dendritic, cyclic, and/or star-shaped polymeric architectures. The phthalate-containing polymer can be a copolymer, for example, a random copolymer, block copolymer, multiblock copolymer, alternating copolymer, terpolymer, or the like. In an embodiment, the phthalate-containing polymer can be a poly(ethylene phthalate) homopolymer (e.g., poly(ethylene terephthalate) (PET) homopolymer), or a polyester copolymer comprising ethylene phthalate repeat units, for example a poly(ethylene phthalate-co-butylene phthalate) copolymer comprising ethylene phthalate and butylene phthalate repeat units (e.g., a poly(ethylene terephthalate-co-butylene terephthalate) copolymer comprising ethylene terephthalate and butylene terephthalate repeat units).

In some embodiments, the phthalate-containing polymer (e.g., terephthalate-containing polymer) can be part of a composition containing other polymers, for example poly(vinyl chloride) (PVC). In such embodiments, the other polymers (e.g., PVC) can be present in an amount of from about 0 wt. % to about 5 wt. %, alternatively from about 0 wt. % to about 1 wt. %, alternatively from about 0 wt. % to about 0.1 wt. %, or alternatively from about 0 wt. % to about 0.001 wt. %, based on a total weight of the phthalate-containing polymer. The phthalate-containing polymer can contain low density polyethylene (LDPE) and/or high density polyethylene (HDPE) in an amount of from about 0 wt. % to about 5 wt. %, alternatively from about 0 wt. % to about 1 wt. %, alternatively from about 0 wt. % to about 0.1 wt. %, or alternatively from about 0 wt. % to about 0.001 wt. %, based on a total weight of the phthalate-containing polymer.

In an embodiment, the phthalate-containing polymer (e.g., terephthalate-containing polymer) can further comprise additives, for example impact modifiers such as bulk acrylonitrile-butadiene-styrene (ABS), acrylonitrile-butadiene-styrene emulsions, styrene-acrylonitrile (SAN), or any other suitable thermoplastic and/or thermoset polymers, for example polycarbonate. In an embodiment, a total amount of polymer other than the terephthalate-containing polymer can be from about 0 wt. % to about 20 wt. %, alternatively from about 0 wt. % to about 10 wt. %, alternatively from about 0 wt. % to about 5 wt. %, or alternatively from about 0 wt. % to about 1 wt. %, based on a total weight of the phthalate-containing polymer.

In an embodiment, the phthalate-containing polymer (e.g., terephthalate-containing polymer) can further comprise any other suitable additives known for use in formulating the phthalate-containing polymer, for example mold release agents, UV stabilizers, anti-drip agents, antioxidants, flame retardants, flame retardant synergists, heat stabilizers, quenchers, phosphate stabilizers, pigments, dyes, titanium dioxides, carbon blacks, talcs, glasses, calcium carbonate, and the like, or combinations thereof. In an embodiment, a total amount of all additives can be from about 0 wt. % to about 20 wt. %, alternatively from about 0 wt. % to about 15 wt. %, alternatively from about 0 wt. % to about 10 wt. %, or alternatively from about 0 wt. % to about 5 wt. %, based on a total weight of the phthalate-containing polymer.

Referring to the embodiment of FIG. 1, a waste polymer stream 1 (e.g., waste PET stream) can be introduced to the pre-treatment unit 50 to produce a pre-treated waste polymer stream 2 (e.g., pre-treated waste PET stream). In an embodiment, the waste polymer stream (e.g., waste phthalate-containing polymer stream, waste terephthalate-containing polymer stream, waste PET stream) can be obtained from any suitable source, which can include manufacturing overrun or scrap, or used consumable goods (e.g., post-consumer goods) such as beverage bottles, food containers, other liquid containers, packaging, food packaging, synthetic fibers, synthetic films, synthetic yarns, and the like, or combinations thereof.

In an embodiment, the waste polymer stream 1 can be subjected to one or more pre-treatment steps in the pre-treatment unit 50 to produce the pre-treated waste polymer stream 2 (e.g., pre-treated waste PET stream). Nonlimiting examples of pre-treatment steps suitable for use in the present disclosure for preparing the waste polymer stream for depolymerization can include one or more of i) sorting, ii) pre-washing, iii) cutting (e.g., coarse cutting), iv) removal of stones, glass and metal, v) air sifting to remove film, paper and labels, vi) grinding, dry and/or wet, vii) removal of other types of polymers, such as poly(vinyl chloride), high density poly(ethylene), low density poly(ethylene), and/or other polymers, viii) washing (e.g., hot washing), ix) caustic wash, x) surface etching (e.g., caustic surface etching), xi) rinsing, xii) clean water rinsing, xiii) drying and/or wetting, xiv) air sifting of flakes (e.g., air sifting to remove flakes), xv) flake sorting, and the like, or combinations thereof. The pre-treatment steps can be used singularly or in combination, in any desirable order to prepare the phthalate-containing polymer (e.g., terephthalate-containing polymer, PET) for a depolymerization reaction.

In an embodiment, the phthalate-containing polymer (e.g., terephthalate-containing polymer) subjected to one or more pre-treatment steps can be in the form of a chip, flake, granule, powder, and/or other particle form that preferably does not become airborne dust in a manufacturing plant.

In an embodiment, the phthalate-containing polymer (e.g., terephthalate-containing polymer) can be depolymerized to provide bis(hydroxyalkyl) phthalate (e.g., bis(hydroxyalkyl) terephthalate) in a depolymerization unit.

Referring to the embodiment of FIG. 1, at least a portion of the pre-treated waste polymer stream 2 (e.g., pre-treated waste PET stream), a C₂₋₅ alkylene diol stream 3 (e.g., ethylene glycol stream, fresh ethylene glycol stream), and a catalyst stream 4 can be introduced to the depolymerization unit 100 to produce a crude product stream 5, wherein the crude product can comprise a monomer (e.g., bis(hydroxyalkyl) phthalate monomer, bis(hydroxyalkyl) terephthalate monomer, etc.), impurities, and the C₂₋₅ alkylene diol. In an embodiment, the catalyst for the depolymerization comprises tetrapropyl titanate (TPT), zinc acetate, any other suitable organometallic compounds, and the like, or combinations thereof.

In an embodiment, the pre-treated waste polymer can be depolymerized in a batch process or a continuous stirred tank reactors (CSTR) through alcoholysis, which involves another reactant, preferably a C₂₋₅ alkylene diol (e.g., ethylene glycol), and uses TPT as a preferred catalyst. In an embodiment, the depolymerization can be conducted at a temperature of from about 200° C. to about 300° C., or alternatively from about 220° C. to about 240° C.; and at a pressure of from about 0.01 atm to about 100 atm, or alternatively at about 1 atm. Agitation is preferred for depolymerization, although not required.

In an embodiment, the C₂₋₅ alkylene diol can comprise ethylene glycol, 1,3-propanediol, 1,4-butanediol, 1,2-pentanediol, and the like, or combinations thereof.

In an embodiment, the bis(hydroxyalkyl) phthalate monomer comprises bis(2-hydroxyethyl) phthalate. In an embodiment, the bis(hydroxyalkyl) terephthalate monomer comprises bis(2-hydroxyethyl) terephthalate (BHET).

In an embodiment, the monomer (e.g., bis(hydroxyalkyl) phthalate monomer, bis(2-hydroxyethyl) phthalate, bis(hydroxyalkyl) terephthalate monomer, BHET, etc.), as the desired product of the depolymerization, can be present in the crude product in an amount of from about 50 wt. % to 100 wt. %, or alternatively from about 90 wt. % to about 100 wt. %, based on the total weight of the crude product. As will be appreciated by one of skill in the art, and with the help of this disclosure, the amount of monomer in the crude product can depend on the amount of C₂₋₅ alkylene diol, catalyst, and waste polymer used.

For purposes of the disclosure herein, the term “impurity” or “impurities” refers to all components in the crude product other than the monomer and the C₂₋₅ alkylene diol. In an embodiment, the impurities can comprise dimers, trimers, isomers, and oligomers of the monomer (e.g., bis(hydroxyalkyl) phthalate monomer, bis(2-hydroxyethyl) phthalate, bis(hydroxyalkyl) terephthalate monomer, BHET, etc.), pigments and/or additives in the feedstock of waste polymer (e.g., waste PET), dirt, labels that were not removed in the pre-treatment steps, and the like, or combinations thereof. In an embodiment, impurities can comprise bis(hydroxyalkyl) phthalate isomers, bis(hydroxyalkyl) phthalate oligomers, bis(hydroxyalkyl) phthalate dimers, bis(hydroxyalkyl) phthalate trimers, pigments, labels, and the like, or combinations thereof.

In some embodiments, the crude product can be in a liquid phase, for example if the temperature is above about 70° C. to 80° C., due to the presence of C₂₋₅ alkylene diol. In other embodiments, the crude product can be in a solid phase, like a wet powder, for example if the temperature is below about 70° C. to 80° C. The crude product could be white or could have a color if there was pigment in the waste polymer.

In an embodiment, depolymerization processes for phthalate-containing polymers (e.g., terephthalate-containing polymers) are described in more detail in U.S. Pat. No. 9,127,136, which is incorporated by reference herein in its entirety.

In an embodiment, the bis(hydroxyalkyl) phthalate (e.g., bis(hydroxyalkyl) terephthalate) can be separated from a composition comprising depolymerized phthalate-containing polymer (e.g., crude product) in a liquid chromatography unit (e.g., continuous multi-column liquid chromatography unit) to produce an extract stream and a raffinate stream, wherein the extract stream can comprises bis(hydroxyalkyl) phthalate monomer, C₂₋₅ alkylene diol, and solvent, and wherein the raffinate stream can comprises first impurities, C₂₋₅ alkylene diol, and solvent.

Referring to the embodiment of FIG. 1, at least a portion of the crude product stream 5, and a solvent stream 6 can be introduced to the mixing unit 150 to produce a diluted crude product stream 5a, wherein the diluted crude product stream 5a can comprise monomer (e.g., bis(hydroxyalkyl) phthalate monomer, bis(hydroxyalkyl) terephthalate monomer, etc.), impurities, C₂₋₅ alkylene diol, and solvent.

In an embodiment, the solvent can comprise one or more solvents selected from the group consisting of water, N,N-dimethylformamide, methanol, ethanol, n-propanol, iso-propanol, n-butanol, ethers, diethyl ether, isopropyl ether, t-butyl ether, methyl tert-butyl ether, 1,4-dioxane, oxane, tetrahydrofuran, a C₃₋₈ ketone, acetone, acetonitrile, ethylene glycol, pentanes, hexanes, heptanes, octanes, and dichloromethane. In an embodiment, the crude product can be dissolved in any suitable solvent, which can be a single solvent or a combination of several solvents. For purposes of the disclosure here, the terms “solvent” and “mobile phase solvent” can be used interchangeably. In some embodiments, the solvent stream 6 (e.g., fresh solvent stream, fresh mobile phase solvent stream, etc.) can represent only a small amount of the solvent introduced to the mixing unit 150, to compensate for solvent lost during purging and any other losses, wherein recycle solvent streams can be introduced to the mixing unit, as will be described in more detail later herein.

In an embodiment, at least a portion of the diluted crude product stream 5a can be introduced to the cooling/decanting unit 160 to produce a cooled crude product stream 5b and an undissolved impurities stream 7, wherein the undissolved impurities can comprise dirt, labels, unreacted reactants, and the like, or combinations thereof, and wherein the cooled crude product stream can comprise monomer (e.g., bis(hydroxyalkyl) phthalate monomer, bis(hydroxyalkyl) terephthalate monomer, etc.), first impurities (e.g., soluble impurities), C₂₋₅ alkylene diol, and solvent. In an embodiment, the diluted crude product can be cooled down to a temperature of about 20° C. to 23° C. The diluted crude product can be decanted to remove any undissolved materials (e.g., undissolved impurities) before sending the cooled crude product stream to the liquid chromatography unit (e.g., continuous multi-column liquid chromatography unit). In an embodiment, the first impurities can comprise bis(hydroxyalkyl) phthalate isomers, bis(hydroxyalkyl) phthalate oligomers, bis(hydroxyalkyl) phthalate dimers, bis(hydroxyalkyl) phthalate trimers, pigments, and the like, or combinations thereof. For purposes of the disclosure herein, the term “first impurities” refers to all impurities remaining in the cooled crude product stream after decanting, regardless of whether such impurities are dissolved in the cooled crude product or whether they are just fine particulates suspended in the cooled crude product. In an embodiment, at least a portion of the undissolved impurities stream 7 can be introduced to the waste treatment unit 700. For example, the waste water treatment unit can separate solids from waste aqueous streams and incinerate such solids. Further, for example, the waste water can be charged into a carbon bed to remove most of the organic contaminates and then passed through a membrane separation to finally meet the discharge requirement.

In an embodiment, at least a portion of the cooled crude product stream 5b can be introduced to the liquid chromatography unit 200 (e.g., a continuous multi-column liquid chromatography unit) to produce a raffinate stream 12 and an extract stream 13, wherein the extract stream can comprises bis(hydroxyalkyl) phthalate monomer, C₂₋₅ alkylene diol, and solvent, and wherein the raffinate stream can comprises first impurities, C₂₋₅ alkylene diol, and solvent. In an embodiment, the liquid chromatography unit 200 can operate at a temperature of from about 20° C. to about 35° C., and can comprise a first outlet and a second outlet, wherein a first outlet can allow for the recovery of the extract stream, and wherein a second outlet can allow for the recovery of the raffinate stream.

In an embodiment, the liquid chromatography unit can comprise a continuous multi-column liquid chromatography unit, a stationary bed chromatography unit, and the like, or combination thereof. In an embodiment, the continuous multi-column liquid chromatography unit can comprise simulated moving bed (SMB) chromatography, partition, ion exchange, molecular exclusion, and affinity chromatography. In an embodiment, the continuous multi-column liquid chromatography unit can comprise an SMB chromatography unit.

In an embodiment, at least a portion of the extract stream can be vacuum distilled to produce a first solvent stream and a monomer and diol stream, wherein the monomer and diol stream comprises the bis(hydroxyalkyl) phthalate monomer and the C₂₋₅ alkylene diol.

Referring to the embodiment of FIG. 1, at least a portion of the extract stream 13 can be introduced to a vacuum distillation unit 400 (e.g., a first vacuum distillation unit) to produce a first solvent stream 10 and a monomer and diol stream 15. In an embodiment, vacuum distilling at least a portion of the extract stream can be conducted at a pressure of from about 0.05 atm to about 0.25 atm, alternatively from about 0.75 atm to about 0.225 atm, or alternatively from about 0.1 atm to about 0.2 atm. Without wishing to be limited by theory, pressures above about 0.25 atm in the vacuum distillation unit 400 could lead to polymerization of the monomers inside the vacuum distillation unit or column.

In an embodiment, the vacuum distillation unit 400 can comprise any suitable vacuum distillation column, such as for example a vacuum distillation column with trays, a vacuum distillation column with packing material, and the like, or combinations thereof. Nonlimiting examples of packing materials suitable for use in vacuum distillation units in the current disclosure can include particles, beads, rings, Raschig rings, ceramic, metal, glass, and the like, or combinations thereof.

In an embodiment, the first solvent stream 10 can be recovered as a distillate stream at a top of the vacuum distillation column. In an embodiment, the first solvent stream can comprise the solvent (e.g., the solvent that was used in the liquid chromatography unit for separating the monomer from the first impurities). In an embodiment, the first solvent stream can comprise C₂₋₅ alkylene diol in an amount of less than about 0.1 mol %, alternatively less than about 0.05 mol %, or alternatively less than about 0.01 mol %.

In an embodiment, at least a portion of the first solvent stream can be further recycled to the liquid chromatography unit. In an embodiment, at least a portion of the first solvent stream 10 can be further recycled to the mixing unit 150. As will be appreciated by one of skill in the art, and with the help of this disclosure, the solvent (e.g., recycled solvent, fresh solvent) introduced to the mixing unit is the solvent used for the separation of the monomer in the liquid chromatography unit.

In an embodiment, the monomer and diol stream 15 can be recovered as a bottoms stream at a bottom of the vacuum distillation column. In an embodiment, the monomer and diol stream can comprises the bis(hydroxyalkyl) phthalate monomer in an amount of from about 0.7 mol % to about 0.95 mol %, alternatively from about 0.75 mol % to about 0.85 mol %, or alternatively from about 0.75 mol % to about 0.8 mol %.

In an embodiment, the monomer and diol stream can comprises the C₂₋₅ alkylene diol in an amount of from about 0.2 mol % to about 0.3 mol %, alternatively from about 0.2 mol % to about 0.25 mol %, or alternatively from about 0.23 mol % to about 0.25 mol %.

In an embodiment, at least a portion of the monomer and diol stream can be subjected to steam separation (e.g., steam precipitation) to produce a monomer stream and a diol stream, wherein the monomer stream can comprise the bis(hydroxyalkyl) phthalate monomer and water, and wherein the diol stream can comprise the C₂₋₅ alkylene diol and water. As will be appreciated by one of skill in the art, and with the help of this disclosure, a complete separation of monomer from the C₂₋₅ alkylene diol cannot be done sufficiently by flash or distillation. In some embodiments, the steam separation can comprise steam precipitation.

In some embodiments, at least a portion of the monomer and diol stream can be subjected to steam precipitation to produce a monomer stream and a diol stream, wherein a hot steam stream (e.g., steam stream 18) can remove the diol from the monomer and diol stream, thereby causing the monomer to precipitate (e.g., become a solid). In other embodiments, at least a portion of the monomer and diol stream can be subjected to steam separation to produce a monomer stream and a diol stream, wherein a hot steam stream (e.g., steam stream 18) can remove the diol from the monomer and diol stream, and wherein the monomer can be separated as a liquid (e.g., recovered as a liquid monomer stream).

Referring to the embodiment of FIG. 1, at least a portion of the monomer and diol stream 15 and a steam stream 18 can be introduced to the steam separation unit 500 to produce a monomer stream 16 and a diol stream 17. In an embodiment, the steam separation can be conducted at a temperature of from about 100° C. to about 220° C., alternatively from about 180° C. to about 210° C., or alternatively from about 190° C. to about 200° C. In an embodiment, the steam separation can be conducted at a pressure of from about 2 atm to about 10 atm, alternatively from about 3 atm to about 9 atm, or alternatively from about 4 atm to about 8 atm. In some embodiments, the steam separation unit 500 can comprise a steam precipitation unit.

In an embodiment, the steam stream 18 (e.g., hot steam) can be introduced to the steam separation unit 500 at a weight ratio of steam to C₂₋₅ alkylene diol of from about 1:1 to about 2.5:1, alternatively from about 1.1:1 to about 2.25:1, or alternatively from about 1.5:1 to about 2.0:1.

In an embodiment, the steam (e.g., steam stream 18) can be characterized by a temperature of from about 100° C. to about 220° C., alternatively from about 180° C. to about 210° C., or alternatively from about 190° C. to about 200° C. Without wishing to be limited by theory, the temperature of the steam should be sufficiently high to vaporize the C₂₋₅ alkylene diol, and at the same time it should be sufficiently low to avoid vaporizing or polymerizing the monomer.

In an embodiment, the steam (e.g., steam stream 18) can be characterized by a pressure of from about 2 atm to about 10 atm, alternatively from about 3 atm to about 9 atm, or alternatively from about 4 atm to about 8 atm. Without wishing to be limited by theory, the pressure of the steam should be sufficiently high to supply a driving force for the devolatilization (e.g., vaporizing of the C₂₋₅ alkylene diol), but must be low enough to minimize condensation of the steam.

In an embodiment, the steam separation can comprise spraying at least a portion of the monomer and diol stream into a steam atmosphere (e.g., flowing steam atmosphere), wherein the steam atmosphere is created by the steam stream introduced to the steam separation unit. In such embodiment, the C₂₋₅ alkylene diol of the monomer and diol stream can evaporate in the steam atmosphere to produce the diol stream. The diol stream comprising the C₂₋₅ alkylene diol and water (e.g., in the form of steam) can be recovered from the steam separation unit, for example via an outlet located at a top portion of the steam separation unit. As will be appreciated by one of skill in the art, and with the help of this disclosure, the C₂₋₅ alkylene diol that vaporizes in the steam atmosphere creates a mixture a vaporized C₂₋₅ alkylene diol and steam that can be recovered at a top of the steam separation unit. In some embodiments, at least a portion of the diol stream can be communicated to the distillation unit 600 as a vapor stream. In other embodiments, at least a portion of the diol stream can be condensed prior to communicating the diol stream (e.g., as a liquid stream) to the distillation unit 600.

In an embodiment, the diol stream can comprise the C₂₋₅ alkylene diol in an amount of from about 0.1 mol % to about 0.3 mol %, alternatively from about 0.2 mol % to about 0.25 mol %, or alternatively from about 0.23 mol % to about 0.25 mol %.

In an embodiment, vaporizing the C₂₋₅ alkylene diol of the monomer and diol stream can lead to the formation of solid particles of monomer, wherein a portion of the steam can condense on the monomer particles, thereby forming a wet powder. In an embodiment, the monomer stream comprising the bis(hydroxyalkyl) phthalate monomer and water (e.g., monomer wet powder) can be recovered from the steam separation unit (e.g., steam precipitation unit), for example via an outlet located at a bottom portion of the steam separation unit.

In an embodiment, the monomer stream can comprises water in an amount of from about 0.01 wt. % to about 2 wt. %, alternatively from about 0.01 wt. % to about 1 wt. %, or alternatively from about 0.01 wt. % to about 0.1 wt. %.

In an embodiment, steam separation (e.g., steam precipitation) processes are described in more detail in U.S. Pat. No. 6,362,304, which is incorporated by reference herein in its entirety.

In an embodiment, at least a portion of the monomer stream can be cooled to produce a cooled bis(hydroxyalkyl) phthalate monomer (e.g., a wet powder) and a first water stream. In such embodiment, at least a portion of the cooled bis(hydroxyalkyl) phthalate monomer can be dried to produce recovered bis(hydroxyalkyl) phthalate monomer. Since the monomer stream yields a wet powder, one or more dryers can be employed to remove residual water from the wet powder to produce a dry product powder with less than about 1 wt. % water in it. The residual water removed in dryers can sent back to steam generation, to produce at least a portion of the steam used in the steam separation unit.

In an embodiment, the recovered bis(hydroxyalkyl) phthalate monomer comprises less than about 1 wt. % water, alternatively less than about 0.5 wt. % water, alternatively less than about 0.1 wt. % water, or alternatively less than about 0.01 wt. % water, based on the total weight of the bis(hydroxyalkyl) phthalate monomer.

In an embodiment, any suitable dryer can be used for drying the monomer wet powder, such as for example batch dryer, continuous dryer, spray dryer, fluidized bed dryer, spray dryer, vacuum dryer, drum dryer, rotary dryer, fixed tube rotary dryer, pneumatic dryer, band dryer, pulse dryer, and the like, or combinations thereof.

Referring to the embodiment of FIG. 1, at least a portion of the monomer stream 16 can be introduced to the drying/cooling unit 550 to produce bis(hydroxyalkyl) phthalate monomer 21 and a first water stream 22 (e.g., residual water). At least a portion of the first water stream 22 can be introduced to the steam generation unit 560 to produce the steam stream 18. In an embodiment, at least a portion of the first water stream can be used for producing at least a portion of the steam that is used in the step of subjecting at least a portion of the monomer and diol stream to steam separation.

In an embodiment, at least a portion of the recovered bis(hydroxyalkyl) phthalate monomer can be recycled, for example by re-polymerizing at least a portion of the recovered bis(hydroxyalkyl) phthalate monomer to produce a phthalate-containing polymer.

Referring to the embodiment of FIG. 1, at least a portion of the diol stream 17 can be introduced to the distillation unit 600 to produce a first recovered C₂₋₅ alkylene diol stream 11 and a second water stream 25.

In an embodiment, the distillation unit can comprise any suitable distillation column, such as for example a distillation column with trays, a distillation column with packing material, and the like, or combinations thereof. Nonlimiting examples of packing materials suitable for use in distillation units in the current disclosure can include particles, beads, rings, Raschig rings, ceramic, metal, glass, and the like, or combinations thereof.

In an embodiment, the second water stream 25 can be recovered as a distillate stream at a top of the distillation column. In an embodiment, the second water stream can comprise C₂₋₅ alkylene diol in an amount of less than about 1 wt. %, alternatively less than about 0.1 wt. %, or alternatively less than about 0.05 wt. %. In an embodiment, at least a portion of the second water stream can be used for producing at least a portion of the steam that is used in the step of subjecting at least a portion of the monomer and diol stream to steam separation.

In an embodiment, at least a portion of the second water stream 25 can be introduced to the purge unit 650 to produce a purged water stream 26, and a waste water stream 27. Purging the second water stream 25 can remove solid waste particulates that could be present to prevent accumulation of solids in the steam generation unit and associated piping, wherein such waste particulates can be recovered in the waste water stream 27. The waste water stream 27 can comprise water, solid particulates, and C₂₋₅ alkylene diol. In an embodiment, at least a portion of the waste water stream 27 can be introduced to the waste treatment unit 700.

In an embodiment, the purged water stream 26 can comprise water and C₂₋₅ alkylene diol, wherein the C₂₋₅ alkylene diol can be present in the purged water stream in an amount of less than about 1 wt. %, alternatively less than about 0.1 wt. %, or alternatively less than about 0.05 wt. %. In an embodiment, at least a portion of the purged water stream 26 can be introduced to the steam generation unit 560, to produce the steam stream 18. In an embodiment, a fresh water stream 23 can further be introduced to the steam generation unit 560, to account for any water losses, for example via the waste water stream 27.

In an embodiment, the first recovered C₂₋₅ alkylene diol stream 11 can be recovered as a bottoms stream at a bottom of the distillation column, wherein the first recovered C₂₋₅ alkylene diol stream comprises C₂₋₅ alkylene diol and water. In an embodiment, the first recovered C₂₋₅ alkylene diol stream 11 can comprise water in an amount of less than about 0.1 wt. %, alternatively less than about 0.05 wt. %, or alternatively less than about 0.01 wt. %.

In an embodiment, at least a portion of the first recovered C₂₋₅ alkylene diol stream 11 can be recycled to the depolymerization unit 100.

In an embodiment, at least a portion of the raffinate stream can be vacuum distilled to produce a second solvent stream and a first impurities stream, wherein the first impurities stream can comprise first impurities and the C₂₋₅ alkylene diol.

Referring to the embodiment of FIG. 1, at least a portion of the raffinate stream 12 can be introduced to a vacuum distillation unit 300 (e.g., a second vacuum distillation unit) to produce a second solvent stream 9 and a first impurities stream 14. In an embodiment, vacuum distilling at least a portion of the raffinate stream can be conducted at a pressure of from about 0.1 atm to about 0.8 atm, alternatively from about 0.1 atm to about 0.7 atm, or alternatively from about 0.5 atm to about 0.7 atm. Without wishing to be limited by theory, pressures above about 0.8 atm in the vacuum distillation unit 300 could lead to polymerization of the monomers and/or oligomers inside the vacuum distillation unit or column.

In an embodiment, the vacuum distillation unit 300 can comprise any suitable vacuum distillation column, such as for example as described for the vacuum distillation unit 400.

In an embodiment, the second solvent stream 9 can be recovered as a distillate stream at a top of the vacuum distillation column. In an embodiment, the second solvent stream can comprise the solvent (e.g., the solvent that was used in the liquid chromatography unit for separating the monomer from the first impurities). In an embodiment, the second solvent stream can comprise C₂₋₅ alkylene diol in an amount of less than about 0.1 mol %, alternatively less than about 0.05 mol %, or alternatively less than about 0.01 mol %.

In an embodiment, at least a portion of the second solvent stream can be further recycled to the liquid chromatography unit. In an embodiment, at least a portion of the second solvent stream 9 can be further recycled to the mixing unit 150. As will be appreciated by one of skill in the art, and with the help of this disclosure, the solvent (e.g., recycled solvent, fresh solvent) introduced to the mixing unit is the solvent used for the separation of the monomer in the liquid chromatography unit.

In an embodiment, the first impurities stream 14 can be recovered as a bottoms stream at a bottom of the vacuum distillation column. In an embodiment, the first impurities stream can comprises first impurities in an amount of from about 0.1 wt. % to about 0.3 wt. %, alternatively from about 0.2 wt. % to about 0.25 wt. %, or alternatively from about 0.2 wt. % to about 0.22 wt. %. In an embodiment, the first impurities stream can comprises the C₂₋₅ alkylene diol in an amount of from about 0.8 mol % to about 0.95 mol %, alternatively from about 0.9 mol % to about 0.95 mol %, or alternatively from about 0.93 mol % to about 0.94 mol %.

In an embodiment, at least a portion of the first impurities stream 14 can be further cooled in the cooling unit 350 to produce a cooled first impurities stream 14a. In an embodiment, the first impurities stream 14 can be characterized by a temperature of from about 100° C. to about 210° C., alternatively from about 180° C. to about 190° C., or alternatively from about 185° C. to about 188° C. In an embodiment, the cooled first impurities stream 14a can be characterized by a temperature of from about 20° C. to about 100° C., alternatively from about 80° C. to about 95° C., or alternatively from about 88° C. to about 90° C.

In an embodiment, at least a portion of the cooled first impurities stream 14a can be further introduced to the decanting unit 360 to produce a second impurities stream 20, and an undissolved impurities stream 19, wherein an amount of impurities (e.g., second impurities) in the second impurities stream 20 is smaller than an amount of impurities (e.g., first impurities) in the first impurities stream 14. As will be appreciated by one of skill in the art, and with the help of this disclosure, cooling the first impurities stream 14 reduces the solubility of the impurities, and more impurities will come out the solution and become “undissolved impurities” when the temperature is lowered. Generally, solubility decreases with decreasing the temperature. In an embodiment, at least a portion of the undissolved impurities stream 19 can be introduced to the waste treatment unit 700.

In an embodiment, at least a portion of the second impurities stream 20 can be introduced to the purge unit 370 to produce a second recovered C₂₋₅ alkylene diol stream 8, and an impurities stream 24. Purging the second impurities stream 20 can remove solid impurities that could be present to prevent accumulation of solids in a loop for recycling the second recovered C₂₋₅ alkylene diol to the depolymerization unit. In an embodiment, at least a portion of the impurities stream 24 can be introduced to the waste treatment unit 700.

In an embodiment, the second recovered C₂₋₅ alkylene diol stream can comprise impurities and C₂₋₅ alkylene diol, wherein the impurities can be present in the second recovered C₂₋₅ alkylene diol stream in an amount of less than about 0.15 wt. %, alternatively less than about 0.13 wt. %, or alternatively less than about 0.12 wt. %. In an embodiment, at least a portion of the second recovered C₂₋₅ alkylene diol stream 8 can be recycled to the depolymerization unit 100.

In an embodiment, a method of processing one or more streams in a PET recycling system can comprise (a) receiving an extract stream from a continuous multi-column liquid chromatography unit, wherein the continuous multi-column liquid chromatography unit can be part of the PET recycling system, and wherein the extract stream comprises BHET monomer, ethylene glycol, and a mobile phase solvent; (b) vacuum distilling at least a portion of the extract stream at a pressure of about 0.15 atm to produce a first mobile phase solvent stream and a monomer and glycol stream, wherein the monomer and glycol stream comprises the BHET monomer and ethylene glycol; (c) subjecting at least a portion of the monomer and glycol stream to steam separation at a temperature of from about 190° C. to about 200° C. and a pressure of from about 2 atm to about 10 atm to produce a monomer stream and a glycol stream, wherein the monomer stream comprises the BHET monomer and water, wherein the glycol stream comprises ethylene glycol and water, and wherein a steam to ethylene glycol weight ratio can be from about 1:1 to about 1:2.5; and (d) recycling at least a portion of the first mobile phase solvent stream to the continuous multi-column liquid chromatography unit. In such embodiment, the method can further comprise recovering the BHET monomer from the monomer stream to yield recovered BHET monomer and recycling at least a portion of the recovered BHET monomer, wherein recycling at least a portion of the recovered BHET monomer comprises re-polymerizing at least a portion of the recovered BHET monomer to produce a PET polymer. In such embodiment, the steam separation can comprise steam precipitation.

In an embodiment, a method of processing one or more streams in a PET recycling system can comprise (a) receiving a raffinate stream from a continuous multi-column liquid chromatography unit, wherein the continuous multi-column liquid chromatography unit can be part of the PET recycling system, and wherein the raffinate stream comprises first impurities, ethylene glycol, and a mobile phase solvent; (b) vacuum distilling at least a portion of the raffinate stream at a pressure of from about 0.5 atm to about 0.7 atm to produce a second mobile phase solvent stream and a first impurities stream, wherein the first impurities stream comprises first impurities and ethylene glycol; and (c) recycling at least a portion of the second mobile phase solvent stream to the continuous multi-column liquid chromatography unit.

In an embodiment, a method of processing one or more streams in a PET recycling system can comprise (a) receiving an extract stream and a raffinate stream from a continuous multi-column liquid chromatography unit, wherein the continuous multi-column liquid chromatography unit is part of the PET recycling system, wherein the extract stream comprises BHET monomer, ethylene glycol, and a mobile phase solvent, and wherein the raffinate stream comprises first impurities, ethylene glycol, and a mobile phase solvent; (b) vacuum distilling at least a portion of the extract stream at a pressure of about 0.15 atm to produce a first solvent stream and a monomer and glycol stream, wherein the monomer and glycol stream comprises the BHET monomer and ethylene glycol; (c) subjecting at least a portion of the monomer and glycol stream to steam separation at a temperature of from about 190° C. to about 200° C. and a pressure of from about 2 atm to about 10 atm to produce a monomer stream and a glycol stream, wherein the monomer stream comprises the BHET monomer and water, wherein the glycol stream comprises ethylene glycol and water, and wherein a steam to ethylene glycol weight ratio can be from about 1:1 to about 1:2.5; (d) vacuum distilling at least a portion of the raffinate stream at a pressure of from about 0.5 atm to about 0.7 atm to produce a second mobile phase solvent stream and a first impurities stream, wherein the first impurities stream comprises first impurities and ethylene glycol; and (e) recycling at least a portion of the first mobile phase solvent stream and/or at least a portion of the second mobile phase solvent stream to the continuous multi-column liquid chromatography unit. In such embodiment, the method can further comprise recovering the BHET monomer from the monomer stream to yield recovered BHET monomer and recycling at least a portion of the recovered BHET monomer, wherein recycling at least a portion of the recovered BHET monomer comprises re-polymerizing at least a portion of the recovered BHET monomer to produce a PET polymer. In such embodiment, the steam separation can comprise steam precipitation.

In an embodiment, a method of processing one or more streams in a PET recycling system can comprise (a) depolymerizing PET to provide BHET monomer; (b) separating the BHET monomer from a composition comprising depolymerized PET in a continuous multi-column liquid chromatography unit to produce an extract stream and a raffinate stream, wherein the continuous multi-column liquid chromatography unit is part of the PET recycling system, wherein the extract stream comprises BHET, ethylene glycol, and a mobile phase solvent, and wherein the raffinate stream comprises first impurities, ethylene glycol, and a mobile phase solvent; (c) vacuum distilling at least a portion of the extract stream at a pressure of about 0.15 atm to produce a first solvent stream and a monomer and glycol stream, wherein the monomer and glycol stream comprises the BHET monomer and ethylene glycol; (d) subjecting at least a portion of the monomer and glycol stream to steam separation at a temperature of from about 190° C. to about 200° C. and a pressure of from about 2 atm to about 10 atm to produce a monomer stream and a glycol stream, wherein the monomer stream comprises the BHET monomer and water, wherein the diol stream comprises ethylene glycol and water, and wherein a steam to ethylene glycol weight ratio can be from about 1:1 to about 1:2.5; (e) vacuum distilling at least a portion of the raffinate stream at a pressure of from about 0.5 atm to about 0.7 atm to produce a second mobile phase solvent stream and a first impurities stream, wherein the first impurities stream comprises first impurities and ethylene glycol; and (f) recycling at least a portion of the first mobile phase solvent stream and/or at least a portion of the second mobile phase solvent stream to the continuous multi-column liquid chromatography unit. In such embodiment, the method can further comprise recovering the BHET monomer from the monomer stream to yield recovered BHET monomer and recycling at least a portion of the recovered BHET monomer, wherein recycling at least a portion of the recovered BHET monomer comprises re-polymerizing at least a portion of the recovered BHET monomer to produce a PET polymer. In such embodiment, the steam separation can comprise steam precipitation.

In an embodiment, a method of processing one or more streams in a phthalate-containing polymer recycling system (e.g., a method for recycling a phthalate-containing polymer) as disclosed herein can advantageously display improvements in one or more method characteristics when compared to an otherwise similar method that does not recover and/or recycle large amounts of solvents used in the liquid chromatography process. In an embodiment, a method of processing one or more streams in a phthalate-containing polymer recycling system as disclosed herein can advantageously provide for a sustainable process, which can start from waste material (e.g., waste PET) and end up with high value chemical products (e.g., BHET).

In an embodiment, a method of processing one or more streams in a phthalate-containing polymer recycling system as disclosed herein can advantageously provide a complete process design and integration for producing a bis(hydroxyalkyl) phthalate monomer (e.g., BHET) with a purity of equal to or greater than about 99% from waste polymers (e.g., waste PET).

In an embodiment, a method of processing one or more streams in a phthalate-containing polymer recycling system as disclosed herein can advantageously provide for an environmentally benign process by the elaborate design and integration of the recovery and recycle of solvent(s) and C₂₋₅ alkylene diol (e.g., ethylene glycol). In such embodiment, a total amount of waste discharged from the entire process can be less than about 5%, based on the total weight of the recovered bis(hydroxyalkyl) phthalate monomer (e.g., recovered BHET).

In an embodiment, a method of processing one or more streams in a phthalate-containing polymer recycling system as disclosed herein can advantageously allow for about complete (e.g., substantially complete) recovery of the bis(hydroxyalkyl) phthalate monomer (e.g., BHET) by using steam separation (e.g., steam precipitation) for the separation of the bis(hydroxyalkyl) phthalate monomer (e.g., BHET) from the C₂₋₅ alkylene diol (e.g., ethylene glycol), as such separation cannot be done sufficiently by flash or distillation.

In an embodiment, a method of processing one or more streams in a phthalate-containing polymer recycling system as disclosed herein can advantageously use vacuum distillation for the separation of the bis(hydroxyalkyl) phthalate monomer (e.g., BHET) and the C₂₋₅ alkylene diol (e.g., ethylene glycol) from the solvents, e.g., mobile phase solvent(s)) employed in the liquid chromatography (e.g., continuous multi-column liquid chromatography). Additional advantages of the methods of processing one or more streams in a phthalate-containing polymer recycling system as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

A process for recycling a phthalate-containing polymer as disclosed herein was investigated. More specifically, a computerized simulation using software commercially available from AspenTech was used for investigating a process for recycling poly(ethylene terephthalate) (PET) in accordance with FIG. 1. The depolymerization and continuous multi-column liquid chromatography were also experimentally conducted in the laboratory in addition to being modeled via the Aspen simulation, for example as described in U.S. Pat. No. 9,127,136, which is incorporated by reference herein in its entirety. 76,380 tons post-consumer PET were used as the feedstock in the designed process, wherein the post-consumer PET was pre-treated by water rinsing and then was further cut into flakes. Titanium (IV) isopropoxide (TPT) was used as the catalyst for the depolymerization reaction. Two solvents, tetrahydrofuran (THF) (30 vol. %) and hexanes (70 vol. %), were used as the mobile phase for running a continuous multi-column liquid chromatography. As a final product, 100,009 tons of bis(2-hydroxyethyl) terephthalate (BHET) were generated at 99% purity, which purity meets a critical requirement by downstream processes. The streams produced by liquid chromatography were subjected to simulations for separation of components, in accordance with an overall process described in FIG. 1, and the results for individual stream compositions are displayed in Table 1, wherein the stream numbers correspond to the stream numbers as displayed in FIG. 1. Aspen Plus V8.2 was used to conduct the simulation. All the key components in Table 1 were specified in Aspen as conventional. Only PET as feedstock and the final BHET powder product were specially specified as Solid. NRTL was chosen as the Base method. Unit 100 was simulated as a RCSTR. Since there is no continuous multi-column liquid chromatography available in Aspen, Unit 200 was simulated as a Sep and the real experimental results were given to it. Three distillation columns, Unit 300, 400, and 600 all had 5 stages. Other detailed simulation conditions can be found in Table 1.

TABLE 1

| Stream | | | Composition (tons) | | | | | | | |
|---|---|---|---|---|---|---|---|---|---|---|
| # in | T | P | | Waste | | | Ethylene | | | |
| FIG. 1 | (° C.) | (atm) | BHET | PET | THF | Hexanes | Glycol | Water | Impurities | TPT |
| 1 | 20 | 1 | 0 | 76,380 | 0 | 0 | 0 | 0 | 0 | 0 |
| 2 | 20 | 1 | 0 | 76,380 | 0 | 0 | 0 | 0 | 0 | 0 |
| 3 | 20 | 1 | 0 | 0 | 0 | 0 | 25,000 | 0 | 0 | 0 |
| 4 | 20 | 1 | 0 | 0 | 0 | 0 | 0 | 0 | 0 | 0.01 |
| 5 | 230 | 1 | 100,009 | 0 | 0.03 | 8.88 | 14,481 | 2.5 | 2,041 | 0.01 |
| 6 | 20 | 1 | 0 | 0 | 1 | 10 | 0 | 0 | 0 | 0 |
| 7 | 30 | 1 | 0 | 0 | 0 | 0 | 0 | 0 | Trace | 0 |
| 8 | 90 | 1 | 0 | 0 | 0.03 | 8.88 | 7,007 | 1 | 1,000 | Trace |
| 9 | 53 | 0.7 | 0 | 0 | 705,724 | 1,646,570 | 184 | 0 | 0 | Trace |
| 10 | 15 | 0.15 | 0 | 0 | 705,724 | 1,646,570 | 2.11 | 0 | 0 | Trace |
| 11 | 193 | 0.9 | 0 | 0 | 0 | 0 | 7,144 | 1.5 | 0 | Trace |
| 12 | 30 | 1 | 0 | 0 | 705,724 | 1,646,580 | 7,334 | 1.2 | 2,041 | Trace |
| 13 | 30 | 1 | 100,009 | 0 | 705,724 | 1,646,580 | 7,334 | 1.2 | 0 | Trace |
| 14 | 187 | 0.7 | 0 | 0 | 0.03 | 10 | 7,150 | 1.2 | 2,041 | Trace |
| 15 | 183 | 0.15 | 100,009 | 0 | 0.12 | 10 | 7,331 | 1.2 | 0 | Trace |
| 16 | 183 | 1 | 100,009 | 0 | 0 | 0 | 0 | 3,750 | Trace | 0 |
| 17 | 183 | 1 | 0 | 0 | 0.25 | 20 | 7,519 | 3,750 | 0 | Trace |
| 18 | 200 | 2 | 0 | 0 | 0.12 | 10 | 187 | 7,500 | 0 | Trace |
| 19 | 90 | 1 | 0 | 0 | 0 | 0 | 0 | 0 | 1,020 | 0 |
| 20 | 90 | 1 | 0 | 0 | 0.03 | 10 | 7,150 | 1.2 | 1,020 | Trace |
| 21 | 20 | 1 | 100,009 | 0 | 0 | 0 | 0 | 1,000 | Trace | 0 |
| 22 | 20 | 1 | 0 | 0 | 0 | 0 | 0 | 2,750 | 0 | 0 |
| 23 | 20 | 1 | 0 | 0 | 0 | 0 | 0 | 2,875.5 | 0 | 0 |
| 24 | 90 | 1 | 0 | 0 | Trace | 0.18 | 143 | 0.2 | 20 | Trace |
| 25 | 111 | 0.9 | 0 | 0 | 0.25 | 20 | 375 | 3,748.5 | 0 | Trace |
| 26 | 111 | 0.9 | 0 | 0 | 0.12 | 10 | 187 | 1,874.5 | 0 | Trace |
| 27 | 111 | 0.9 | 0 | 0 | 0.12 | 10 | 187 | 1874 | 0 | Trace |

The results displayed in Table 1 demonstrate that a process for recycling PET as disclosed herein is a sustainable process starting with waste material (e.g., waste PET) and ending up with high value chemical products (e.g., BHET). 76,380 tons post-consumer PET were consumed as the feedstock in the designed process. Generally, current end life for waste PET results mainly in PET buried in landfill sites or burned to generate heat. Obviously, such current treatment approaches are not sustainable. In contrast, the process for recycling PET as disclosed herein results in recovering 100,009 tons of BHET, which has a high value and can be directly used for making new chemical products, for instance, new PET bottles, fibers, food containers, etc.

The process for recycling PET as disclosed herein represents a complete process design and integration for obtaining >99% purity of BHET from waste PET. The purity of the final BHET product is 99%, which allows it to be directly used for making all kinds of new PET products, including bottles, fibers, food containers, etc. The key advantage of the process for recycling PET as disclosed herein over most of prior works is that the prior works do not have an effective way to remove isomers, oligomers, and other soluble impurities from BHET. As the recovered product, the BHET obtained by those approaches (previous works) would not be so pure and would contain at least about 2,041 tons of impurities, which would drops the purity of BHET to no higher than 98%, and therefore, the BHET would not be suitable for making some types of PET products. For example, to make PET fibers for clothes, there should be no isomers that provide transparency functions in the recycled/recovered BHET. However, if the waste PET feedstock is derived from beverage bottles and/or food packaging, the recycled BHET will contain isomers unless removed by the process for recycling PET, such as the process for recycling PET as disclosed herein. The continuous multi-column liquid chromatography as disclosed in U.S. Pat. No. 9,127,136 is designed to remove such undesired isomers and other soluble impurities from the BHET. However, the end product as disclosed in U.S. Pat. No. 9,127,136 comprises 100,009 tons of BHET product still dissolved in the mobile phase of solvents—705,724 tons of THF and 1,646,570 tons of hexanes; and also 7,334 tons of ethylene glycol. As will be appreciated by one of skill in the art, and with the help of tis disclosure, the BHET dissolved in rather large amounts of mobile phase solvents and containing ethylene glycol cannot be directly used in downstream production (e.g., re-polymerization of BHET).

The process for recycling PET as disclosed herein represents an environmentally benign process by an elaborate design and integration of recovery and recycling of solvent(s) and ethylene glycol. From the data displayed in Table 1, it can be seen that a total amount of waste discharged is 4,979 tons, which represents 4.9% to the total product of 100,009 tons of BHET. In contrast, by using approaches in prior works without continuous multi-column liquid chromatography, the minimum waste discharged would be 14.18% based on the weight of the BHET product.

Separation of BHET from ethylene glycol cannot be done sufficiently by flash or distillation. By using steam separation (e.g., steam precipitation), 7,331 tons of ethylene glycol were removed from the final BHET product, as shown in Table 1.

Vacuum distillation was used for the separation of BHET and ethylene glycol from mobile phase solvent(s) employed in the continuous multi-column liquid chromatography. As it can be seen from the data in Table 1, 705,724 tons of THF and 1,646,570 tons of hexanes were recovered in each of the two vacuum distillations and were further recycled. As will be appreciated by one of skill in the art, and with the help of this disclosure, regular distillation would lead to a temperature inside of the distillation column high enough to cause BHET polymerization.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

A first embodiment, which is a method of processing one or more streams in a phthalate-containing polymer recycling system, the method comprising: (a) receiving an extract stream from a liquid chromatography unit, wherein the liquid chromatography unit is part of the phthalate-containing polymer recycling system, and wherein the extract stream comprises a bis(hydroxyalkyl) phthalate monomer, a C₂₋₅ alkylene diol, and a solvent; (b) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol; and (c) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water.

A second embodiment, which is the method of the first embodiment further comprising recycling at least a portion of the first solvent stream to the liquid chromatography unit.

A third embodiment, which is the method of any one of the first and the second embodiments, wherein the step (b) of vacuum distilling at least a portion of the extract stream is conducted at a pressure of from about 0.05 atm to about 0.25 atm.

A fourth embodiment, which is the method of any one of the first through the third embodiments, wherein the steam separation is conducted at a temperature of from about 100° C. to about 220° C.

A fifth embodiment, which is the method of any one of the first through the fourth embodiments, wherein the steam separation is conducted at a pressure of from about 2 atm to about 10 atm.

A sixth embodiment, which is the method of any one of the first through the fifth embodiments, wherein the steam separation comprises contacting at least a portion of the monomer and diol stream with steam at a weight ratio of steam to C₂₋₅ alkylene diol of from about 1:1 to about 2.5:1.

A seventh embodiment, which is the method of any one of the first through the sixth embodiment, wherein the steam separation comprises spraying at least a portion of the monomer and diol stream into a steam atmosphere.

An eighth embodiment, which is the method of the seventh embodiment, wherein the C₂₋₅ alkylene diol of the monomer and diol stream evaporates in the steam atmosphere to produce the diol stream.

A ninth embodiment, which is the method of any one of the first through the eighth embodiments further comprising distilling at least a portion of the diol stream to produce a first recovered C₂₋₅ alkylene diol and a second water stream.

A tenth embodiment, which is the method of the ninth embodiment, wherein at least a portion of the first recovered C₂₋₅ alkylene diol is recycled to a step of depolymerizing a phthalate-containing polymer.

An eleventh embodiment, which is the method of any one of the first through the tenth embodiments, wherein at least a portion of the second water stream is used for producing at least a portion of the steam that is used in the step (c) of subjecting at least a portion of the monomer and diol stream to steam separation.

A twelfth embodiment, which is the method of any one of the first through the eleventh embodiments, wherein at least a portion of the monomer stream is cooled to produce a cooled bis(hydroxyalkyl) phthalate monomer and a first water stream.

A thirteenth embodiment, which is the method of the twelfth embodiment, wherein at least a portion of the first water stream is used for producing at least a portion of the steam that is used in the step (c) of subjecting at least a portion of the monomer and diol stream to steam separation.

A fourteenth embodiment, which is the method of any one of the first through the thirteenth embodiments, wherein at least a portion of the cooled bis(hydroxyalkyl) phthalate monomer is dried to produce recovered bis(hydroxyalkyl) phthalate monomer.

A fifteenth embodiment, which is the method of the fourteenth embodiment, wherein the recovered bis(hydroxyalkyl) phthalate monomer comprises less than about 1 wt. % water, based on the total weight of the bis(hydroxyalkyl) phthalate monomer.

A sixteenth embodiment, which is the method of any one of the first through the fifteenth embodiments, wherein the steam separation comprises steam precipitation.

A seventeenth embodiment, which is a method of processing one or more streams in a phthalate-containing polymer recycling system, the method comprising: (a) receiving a raffinate stream from a liquid chromatography unit, wherein the liquid chromatography unit is part of the phthalate-containing polymer recycling system, and wherein the raffinate stream comprises first impurities, a C₂₋₅ alkylene diol, and a solvent; (b) vacuum distilling at least a portion of the raffinate stream to produce a second solvent stream and a first impurities stream, wherein the first impurities stream comprises first impurities and the C₂₋₅ alkylene diol; and (c) recycling at least a portion of the second solvent stream to the liquid chromatography unit.

An eighteenth embodiment, which is the method of the seventeenth embodiment, wherein the step (b) of vacuum distilling at least a portion of the raffinate stream is conducted at a pressure of from about 0.1 atm to about 0.8 atm.

A nineteenth embodiment, which is the method of any one of the seventeenth and the eighteenth embodiments further comprising cooling at least a portion of the first impurities stream to produce a cooled first impurities stream.

A twentieth embodiment, which is the method of the nineteenth embodiment further comprising decanting at least a portion of the cooled first impurities stream to produce undissolved impurities and a second recovered C₂₋₅ alkylene diol.

A twenty-first embodiment, which is the method of the twentieth embodiment, wherein at least a portion of the second recovered C₂₋₅ alkylene diol is recycled to a step of depolymerizing a phthalate-containing polymer.

A twenty-second embodiment, which is a method of processing one or more streams in a phthalate-containing polymer recycling system, the method comprising: (a) receiving an extract stream and a raffinate stream from a liquid chromatography unit, wherein the liquid chromatography unit is part of the phthalate-containing polymer recycling system, wherein the extract stream comprises a bis(hydroxyalkyl) phthalate monomer, a C₂₋₅ alkylene diol, and a solvent, and wherein the raffinate stream comprises first impurities, a C₂₋₅ alkylene diol, and a solvent; (b) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol; (c) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water; and (d) vacuum distilling at least a portion of the raffinate stream to produce a second solvent stream and a first impurities stream, wherein the first impurities stream comprises first impurities and the C₂₋₅ alkylene diol.

A twenty-third embodiment, which is the method of the twenty-second embodiment further comprising recycling at least a portion of the first solvent stream and/or at least a portion of the second solvent stream to the liquid chromatography unit.

A twenty-fourth embodiment, which is the method of any one of the twenty-second and the twenty-third embodiments, wherein the steam separation comprises steam precipitation.

A twenty-fifth embodiment, which is a method of processing one or more streams in a phthalate-containing polymer recycling system, the method comprising: (a) depolymerizing a phthalate-containing polymer to provide bis(hydroxyalkyl) phthalate; (b) separating the bis(hydroxyalkyl) phthalate from a composition comprising depolymerized phthalate-containing polymer in a continuous multi-column liquid chromatography unit to produce an extract stream and a raffinate stream, wherein the continuous multi-column liquid chromatography unit is part of the phthalate-containing polymer recycling system, wherein the extract stream comprises a bis(hydroxyalkyl) phthalate monomer, a C₂₋₅ alkylene diol, and a solvent, and wherein the raffinate stream comprises first impurities, a C₂₋₅ alkylene diol, and a solvent; (c) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol; (d) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water; and (e) vacuum distilling at least a portion of the raffinate stream to produce a second solvent stream and a first impurities stream, wherein the first impurities stream comprises first impurities and the C₂₋₅ alkylene diol.

A twenty-sixth embodiment, which is the method of the twenty-fifth embodiment further comprising recycling at least a portion of the first solvent stream and/or at least a portion of the second solvent stream to the continuous multi-column liquid chromatography unit.

A twenty-seventh embodiment, which is a the method of any one of the twenty-fifth and the twenty-sixth embodiments, wherein the phthalate-containing polymer comprises a polyester comprising ethylene phthalate units.

A twenty-eighth embodiment, which is the method of any one of the twenty-fifth through the twenty-seventh embodiments, wherein the bis(hydroxyalkyl) phthalate comprises bis(2-hydroxyethyl) phthalate.

A twenty-ninth embodiment, which is the method of any one of the twenty-fifth through the twenty-eighth embodiments, wherein the C₂₋₅ alkylene diol comprises ethylene glycol, 1,3-propanediol, 1,4-butanediol, 1,2-pentanediol, or combinations thereof.

A thirtieth embodiment, which is the method of any one of the twenty-fifth through the twenty-ninth embodiments, wherein the first solvent stream and/or the second solvent stream comprise one or more solvents selected from the group consisting of water, N,N-dimethylformamide, methanol, ethanol, n-propanol, iso-propanol, n-butanol, ethers, diethyl ether, isopropyl ether, t-butyl ether, methyl tert-butyl ether, 1,4-dioxane, oxane, tetrahydrofuran, a C₃₋₈ ketone, acetone, acetonitrile, ethylene glycol, pentanes, hexanes, heptanes, octanes, and dichloromethane.

A thirty-first embodiment, which is the method of any one of the twenty-fifth through the thirtieth embodiments, wherein the first impurities comprise bis(hydroxyalkyl) phthalate isomers, bis(hydroxyalkyl) phthalate oligomers, bis(hydroxyalkyl) phthalate dimers, bis(hydroxyalkyl) phthalate trimers, pigments, or combinations thereof.

A thirty-second embodiment, which is the method of any one of the twenty-fifth through the thirty-first embodiments further comprising recovering the bis(hydroxyalkyl) phthalate monomer from the monomer stream to yield recovered bis(hydroxyalkyl) phthalate monomer and recycling at least a portion of the recovered bis(hydroxyalkyl) phthalate monomer.

A thirty-third embodiment, which is the method of the thirty-second embodiment, wherein recycling at least a portion of the recovered bis(hydroxyalkyl) phthalate monomer comprises re-polymerizing at least a portion of the recovered bis(hydroxyalkyl) phthalate monomer.

A thirty-fourth embodiment, which is the method of any one of the twenty-fifth through the thirty-third embodiments, wherein the steam separation comprises steam precipitation.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. A method of processing one or more streams in a phthalate-containing polymer recycling system, the method comprising:
(a) receiving an extract stream from a liquid chromatography unit, wherein the liquid chromatography unit is part of the phthalate-containing polymer recycling system, and wherein the extract stream comprises a bis(hydroxyalkyl) phthalate monomer, a C₂₋₅ alkylene diol, and a solvent;
(b) vacuum distilling at least a portion of the extract stream to produce a first solvent stream and a monomer and diol stream, wherein the monomer and diol stream comprises the bis(hydroxyalkyl) phthalate monomer and the C₂₋₅ alkylene diol; and
(c) subjecting at least a portion of the monomer and diol stream to steam separation to produce a monomer stream and a diol stream, wherein the monomer stream comprises the bis(hydroxyalkyl) phthalate monomer and water, and wherein the diol stream comprises the C₂₋₅ alkylene diol and water.

2. The method of claim 1 further comprising recycling at least a portion of the first solvent stream to the liquid chromatography unit.

3. The method of claim 1, wherein the step (b) of vacuum distilling at least a portion of the extract stream is conducted at a pressure of from about 0.05 atm to about 0.25 atm.

4. The method of claim 1, wherein the steam separation is conducted at a temperature of from about 100° C. to about 220° C.

5. The method of claim 1, wherein the steam separation is conducted at a pressure of from about 2 atm to about 10 atm.

6. The method of claim 1, wherein the steam separation comprises contacting at least a portion of the monomer and diol stream with steam at a weight ratio of steam to C₂₋₅ alkylene diol of from about 1:1 to about 2.5:1.

7. The method of claim 1, wherein the steam separation comprises spraying at least a portion of the monomer and diol stream into a steam atmosphere, wherein the C₂₋₅ alkylene diol of the monomer and diol stream evaporates in the steam atmosphere to produce the diol stream.

8. The method of claim 1 further comprising distilling at least a portion of the diol stream to produce a first recovered C₂₋₅ alkylene diol and a second water stream, wherein at least a portion of the first recovered C₂₋₅ alkylene diol is recycled to a step of depolymerizing a phthalate-containing polymer.

9. The method of claim 1, wherein at least a portion of the monomer stream is cooled to produce a cooled bis(hydroxyalkyl) phthalate monomer and a first water stream.

10. The method of claim 9, wherein at least a portion of the cooled bis(hydroxyalkyl) phthalate monomer is dried to produce recovered bis(hydroxyalkyl) phthalate monomer, wherein the recovered bis(hydroxyalkyl) phthalate monomer comprises less than about 1 wt. % water, based on the total weight of the bis(hydroxyalkyl) phthalate monomer.

11. The method of claim 1, wherein the steam separation comprises steam precipitation.

12. The method of claim 1, the method further comprising:
(d) receiving a raffinate stream from the liquid chromatography unit, wherein the raffinate stream comprises first impurities, a C₂₋₅ alkylene diol, and a solvent;
(e) vacuum distilling at least a portion of the raffinate stream to produce a second solvent stream and a first impurities stream, wherein the first impurities stream comprises first impurities and the C₂₋₅ alkylene diol; and
(f) recycling at least a portion of the second solvent stream to the liquid chromatography unit.

13. The method of claim 12, wherein the step (e) of vacuum distilling at least a portion of the raffinate stream is conducted at a pressure of from about 0.1 atm to about 0.8 atm.

14. The method of claim 12 further comprising cooling at least a portion of the first impurities stream to produce a cooled first impurities stream.

15. The method of claim 14 further comprising decanting at least a portion of the cooled first impurities stream to produce undissolved impurities and a second recovered C₂₋₅ alkylene diol, wherein at least a portion of the second recovered C₂₋₅ alkylene diol is recycled to a step of depolymerizing a phthalate-containing polymer.

16. The method of claim 12, the method further comprising:
(i) depolymerizing a phthalate-containing polymer to provide bis(hydroxyalkyl) phthalate; and
(ii) separating the bis(hydroxyalkyl) phthalate from a composition comprising depolymerized phthalate-containing polymer in the liquid chromatography unit to produce the extract stream and the raffinate stream, wherein the liquid chromatography unit comprises a continuous multi-column liquid chromatography.

17. The method of claim 1, wherein the bis(hydroxyalkyl) phthalate monomer comprises bis(2-hydroxyethyl) phthalate.

18. The method of claim 1, wherein the C₂₋₅ alkylene diol comprises ethylene glycol, 1,3-propanediol 1,4-butanediol, 1,2-pentanediol, or combinations thereof.

19. The method of claim 16, further comprising recovering the bis(hydroxyalkyl) phthalate monomer from the monomer stream to yield recovered bis(hydroxyalkyl) phthalate monomer and recycling at least a portion of the recovered bis(hydroxyalkyl) phthalate monomer.

20. The method of claim 19, wherein recycling at least a portion of the recovered bis(hydroxyalkyl) phthalate monomer comprises re-polymerizing at least a portion of the recovered bis(hydroxyalkyl) phthalate monomer.
